(19) United States
(12) Patent Application Publication
(10) Pub. No.: US 2025/0104738 A1
(43) Pub. Date: Mar. 27, 2025

(54) IDENTIFICATION, ANNOTATION, AND PLAYBACK OF AUDIO SEGMENTS IN MUSIC PLATFORMS

(71) Applicant: MOISES SYSTEMS, INC., Salt Lake City, UT (US)

(72) Inventors: Eddie Gueiros Hsu, João Pessoa (BR); Jardson Almeida, Salt Lake City, UT (US); Alziro Jose Oliveira Braga, Salt lake City, UT (US); Filip Korzeniowski, Vienna (AT); Richard Karl Vogl, Linz (AT)

(21) Appl. No.: 18/829,940

(22) Filed: Sep. 10, 2024

Related U.S. Application Data
(60) Provisional application No. 63/584,685, filed on Sep. 22, 2023.

(51) Int. Cl. G11B 27/00; G06F 3/0482; G06F 3/16

(52) U.S. Cl. CPC G11B 27/007; G06F 3/0482; G06F 3/165

(57) ABSTRACT

A system is configurable to: (i) access metadata associated with an audio signal, wherein the metadata define a plurality of audio sections for the audio signal; (ii) cause presentation of the plurality of audio sections on a user device; (iii) after user input is directed to the user device for selecting one or more audio sections from the plurality of audio sections presented on the user device, include the one or more audio sections in a looping queue; and (iv) initiate looping playback of the audio signal using the looping queue, wherein the looping playback of the audio signal using the looping queue comprises repeating playback of the one or more audio sections included in the looping queue until a stop condition is satisfied.

### CROSS-REFERENCE TO RELATED APPLICATION(S)

This application claims priority to U.S. Provisional Application No. 63/584,685, filed on Sep. 22, 2023, and entitled “IDENTIFICATION, ANNOTATION, AND PLAYBACK OF AUDIO SEGMENTS IN MUSIC PLATFORMS”, the entirety of which is incorporated herein by reference for all purposes.

### BACKGROUND

In the current state of the music industry, various web and device app platforms offer users the ability to listen to and interact with songs. Many musicians rely on such web and device app platforms during music practice sessions, where musicians practice entire songs and/or parts/segments of songs. To practice parts/segments of songs, users typically have to manually navigate to desired song sections, which can be imprecise and/or cumbersome for users. Some platforms enable labeling and/or annotation of song segments and/or musical parts. However, labeling/annotation processes provided by conventional platforms typically rely on human intervention and manual annotation to set the boundaries of each song part. This annotation process can be time-consuming, cumbersome, and prone to human error due to the complexity of musical structures and the inherent subjectivity involved in defining boundaries between song parts.

Even where boundaries of song segments/sections/parts are defined, existing music platforms fail to offer an experience where users can seamlessly navigate through the song parts without the need for significant and/or repeated human input/attention. Existing music platforms thus provide sub-optimal experiences for educators, music students, enthusiasts, and/or others who may benefit from accurate and reliable song part identification and/or navigation for various purposes.

The subject matter described herein is not limited to embodiments that solve any challenges or that operate only in environments such as those described above. Rather, this background is only provided to illustrate one exemplary technology area where some embodiments described herein may be practiced.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example user interface for facilitating selection of audio content for processing.

FIG. 2 illustrates an example user interface for controlling playback of selected audio content.

FIGS. 3, 4, 5, and 6 illustrate an example user interface for controlling playback of selected audio content using audio sections defined for the selected audio content.

FIG. 7 illustrates an example user interface for controlling looping playback of a selected audio section.

FIGS. 8 and 9 illustrate an example user interface for controlling looping playback of multiple selected audio sections.

FIG. 10 illustrates another example user interface for controlling looping playback of a selected audio section.

FIGS. 11, 12, and 13 illustrate example flow diagrams depicting acts associated with facilitating beat and/or downbeat estimation and/or playback.

FIG. 14 depicts example components of a system that may comprise or be configurable to perform various embodiments.

### DETAILED DESCRIPTION

Conventional methods and systems for annotating music are often time consuming, unintuitive, and prone to human error due to the complexity of musical structures and the inherent subjectivity in defining boundaries between song segments. There exists a need in the industry for systems and methods that automatically annotate music and/or allow for seamless navigation through songs according to precise boundaries (i.e., sections or segments) within the song.

At least some of the embodiments provide systems and methods for automatically identifying and/or annotating song parts in a music platform, effectively eliminating the need for manual human identification and/or annotation. Disclosed systems and methods may utilize advanced techniques to detect song part boundaries and ensure accurate results by incorporating post-processing steps. Additionally, detected segments may be adjusted to the nearest downbeat, enabling seamless looping of segments for improved playback experiences for users (e.g., for musical practice sessions, where users repeatedly playback and practice one or more song segments).

Some features of the present disclosure, which will be discussed in more detail below, include semantic user-interface (UI) navigation, segmental looping capabilities, song segment reordering, and a user feedback mechanism.

Semantic UI navigation capabilities as described herein may allow users to easily navigate through song segments using an intuitive and semantic user interface, allowing them to access specific song sections (or segments) with minimal effort.

Segmental looping capabilities may allow users to seamlessly loop selected song segments. Further, such precise looping techniques can facilitate in-depth analysis and study of a song. Automatically repeating particular song segments can also aid in building muscle memory for musicians, a key skill when developing one's abilities and/or practicing a song. Additionally, segmental looping capabilities may simply allow a user to enjoy a particular section on repeat.

Song segment reordering capabilities as described herein may enable a user to reorder song parts. Such reordering can allow users to create unique listening experiences and/or customize song structures according to their preferences. Such functionality can also assist users in practice scenarios, in particular where users desire to practice song segments outside of their original temporal order.

User feedback mechanisms described herein may enhance the accuracy and adaptability of the disclosed techniques. For instance, a system may attempt to identify song part labels, such as the chorus, verses, etc., by analyzing and/or processing various song attributes and metadata. These attributes and metadata may include vocal and instrument stems, lyric transcriptions, chord progressions, and/or others. The system may then prompt users to accept, reject, and/or modify system-generated segment labels (i.e., labels that are incorrectly named).

User responses (e.g., accepting, rejecting, or modifying system-generated labels) may be utilized as training data to further train components of the system (e.g., AI modules of the system used to automatically determine and/or label song segments). Such functionality may enable continuous improvement of the segment labeling capabilities of the system for future inputs. As a result, systems can become more accurate and/or reliable over time, further enhancing the user experience and ensuring a consistent and precise representation of song parts within the music platform.

At least some disclosed embodiments relate to “smart-seeking” functionality. Music players and tools available today predominantly rely on temporal units such as seconds and/or minutes to facilitate navigation through song contents during playback (with some advanced offerings incorporating beats for navigation). For instance, a user may select a spatial position on a playback navigation bar that corresponds to temporal progression through a song to facilitate navigation toward (or seeking of) a particular part of a song (often referred to as “scrubbing”). However, such methods of navigation fail to align with the way musicians typically communicate with each other. The reliance on time as a unit for navigating music can be limiting since many musicians think of time on an abstract level of bars and beats rather than seconds and minutes. Temporal positions using our standard measurement of time (for example, seconds and/or minutes) may thus comprise a sub-optimal basis for musical navigation.

For instance, musicians in orchestras and music groups working with sheet music often use bar numbers indicated on the music sheets for communication. This method of navigation allows them to navigate through complex compositions with ease. Similarly, for pop and contemporary mainstream music, people typically refer to song segments by their names, e.g., intro, pre-chorus, verse, chorus, bridge, and instrumental. This approach can simplify communication when discussing memorable tracks.

By providing a more humanized approach to music navigation, implementations of the present disclosure aim to eliminate the need for users to select song segment/section locations by selecting, inputting, or navigating to temporal values (e.g., minute and/or second values). Instead, users can navigate songs using familiar terms that resonate more naturally with musicians and music enthusiasts, offering a more enjoyable and intuitive musical experience. For example, guitarists learning a new song can easily navigate to (e.g., seek) and/or loop specific sections such as a solo within a musical composition. Music producers, on the other hand, can efficiently rearrange song segments to create unique remixes or mashups.

At least some implementations of the present disclosure facilitate music navigation by leveraging the power of automatic song part identification, combining it with user feedback and machine learning to create an unparalleled experience for musicians, educators, and music enthusiasts alike.

In addition to conventional seeking/navigation functionality discussed above (e.g., using a navigation bar or array of temporal values), many traditional music players allow users to navigate through songs by providing fast forward or rewind functionality. Some players offer shortcut or skip functionality that allows users to jump a few seconds forward or backward, but these options still lack precision and context for musicians. This rudimentary seeking functionality can be frustrating for musicians, especially when attempting to navigate to or practice specific sections of a song.

At least some disclosed embodiments enable a more intelligent and meaningful way for users to navigate songs. By accurately identifying and annotating song segments such as intros, verses, choruses, and solos, disclosed embodiments can enable musicians to seek directly to the sections they wish to practice or explore.

For example, consider a violinist practicing a part of a song comprising an intricate solo. As the solo progresses, the violinist may want to restart from the beginning of the solo (but not the beginning of the entire song) to perfect their technique. With a traditional music player, seeking toward the exact starting point of the solo within the song would be a game of trial and error, using the limited functionality of fast-forward and rewind (or skip forward and skip backward). However, techniques disclosed herein can enable the violinist to simply select a rewind control (or a skip backward control) to automatically navigate to the beginning of the solo (or the beginning of another current or preceding song section) to start playback precisely at the beginning of the solo.

Such functionality (i.e., smart-seeking) can offer a more efficient and intuitive way for musicians to navigate through songs, allowing them to focus on the most relevant sections for their practice, enjoyment, or other use. By bridging the gap between traditional music players and the needs of musicians, the techniques disclosed herein may improve the way musicians interact with and learn from musical content.

At least some disclosed embodiments relate to smart-looping functionality. Many music practice tools provide users with the option to manually select a range of musical content (e.g., a range of seconds or minutes selected from a navigation bar) to cause looping (e.g., repeated playback) of song parts. Manual selection of musical content for looping can be susceptible to the same imprecision described above and can be cumbersome and/or burdensome for users and can also consume valuable time that could be spent on actual practice or learning.

For instance, imagine a pianist attempting to perfect a challenging section of a piano concerto or a drummer working on the intricate rhythms of a musical composition. In both cases, using conventional methods, the musician has to tediously identify the precise starting and ending points of the section, set the loop boundaries, and save the loop for future practice sessions. This time-consuming process can be frustrating and often detracts from the musician's overall learning experience.

By automating the identification and/or annotation of song segments, the techniques described herein can eliminate the need for users to manually define and/or refine loop sections, thereby streamlining the music practice process. Such functionality can allow musicians to focus on honing their skills, exploring new techniques, and enjoying their practice sessions, without the added stress of managing cumbersome tools. The techniques disclosed herein can thus enable a more seamless and enjoyable experience for musicians of all levels and backgrounds.

Having just described some of the various high-level features and benefits of the disclosed embodiments, attention will now be directed to the Figures, which illustrate various conceptual representations, architectures, methods, and/or supporting illustrations related to the disclosed embodiments.

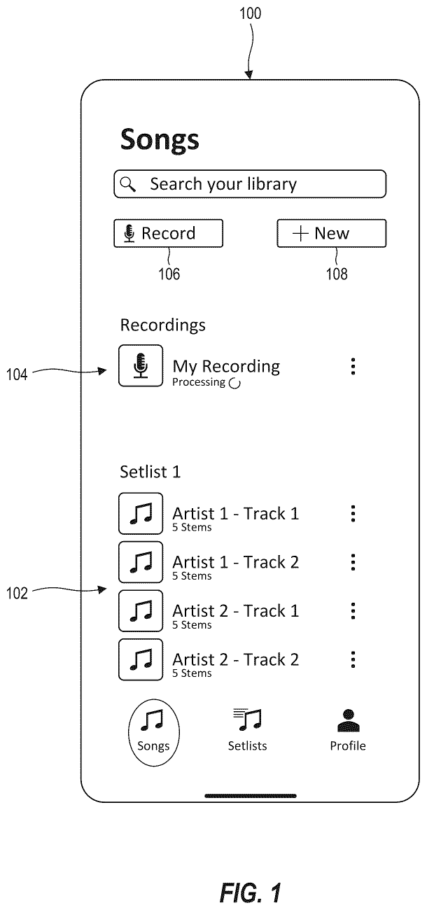

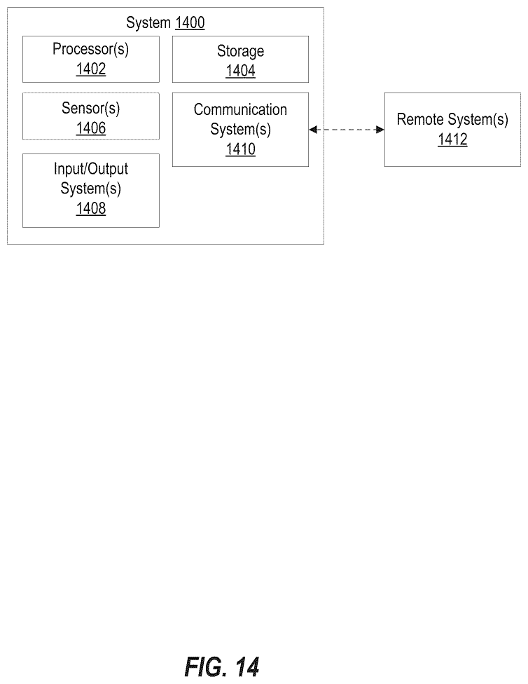

FIG. 1 illustrates an example user interface 100 for facilitating selection of audio content for processing. One or more aspects of the user interface 100 (and other user interfaces described herein) can be presented on various types of devices or systems, such as smartphones, tablets, laptop computers, desktop computers, wearable devices, and/or other devices (e.g., which devices or systems can correspond to or include components of system 1400, described hereinafter with reference to FIG. 14). The user interface 100 can be presented on a user device in association with operation of a downloaded and/or web-based (e.g., server- or cloud-based) application (e.g., a music software application).

In the example shown in FIG. 1, the user interface 100 provides access to various audio content (e.g., audio signals) in the form of audio tracks 102 and audio recordings 104. The audio content may comprise one or more locally and/or remotely stored audio or recording files. The audio content can include data/information allowing for playback of associated audio when used in conjunction with a playback device. In some instances, selected audio content may comprise an audio stream (e.g., provided by a web streaming service, radio-based service, satellite service, line-in connection, etc.). In some implementations audio content may be added to the audio tracks 102 and/or the audio recordings 104 displayed in the user interface 100 via one or more user actions. For example, the user interface 100 includes a record button 106 and an add button 108. The record button 106 may be selectable via user input to facilitate recording of an audio file for inclusion with the audio recordings 104. Similarly, the add button 108 may be selectable via user input to facilitate selection of additional audio files/tracks (e.g., from a local or remote repository, or by selecting one or more music streaming or radio or other audio services) for inclusion with the audio tracks 102.

In some instances, the audio content represented in a user interface 100 includes one or more audio stems. For example, each of the audio tracks 102 are displayed in conjunction with an indicator of the quantity of audio stems (e.g., “5 Stems”) associated with the respective audio track. Audio stems can refer to the component parts of a complete musical track, such as vocals, drums, bass, guitar, keys/piano, and/or other sources of audio.

In the example shown in FIG. 1, the audio recordings 104 includes a newly recorded file referred to herein as “My Recording”. My Recording may have been recorded after selection of the record button 106 of the user interface 100. The user interface 100 of FIG. 1 conceptually depicts processing of the My Recording file with the “Processing” label proximate to the My Recording label. The processing of audio content as indicated in FIG. 1 can comprise performing stem separation (e.g., to isolate individual audio stems represented in the audio content from one another). The processing of the audio content can additionally or alternatively include determining audio sections for the selected audio content, and/or other audio processing operations.

In one example, after selection of audio content shown in the user interface 100 (or after selection of audio content to add to the user interface 100), the audio content may be processed (e.g., via local computing resources, such as those of a client device/system, and/or via remote resources, such as cloud or server resources) to determine the audio sections for the selected audio content. The audio sections of the selected audio content can be represented as one or more data objects, files, or structures in which the timestamps of the sections (e.g., denoting the beginnings, ends, and/or durations of the audio sections along the timeline of the selected audio content) are recorded or logged. In some implementations, the data object, file, or structure that indicates the timestamps of the audio sections comprises, provides a basis for, or is used to generate metadata that can be associated with the selected audio content (e.g., via embedding, packaging, attaching, indexing, coupling, inclusion in a metadata directory, pairing or key-value pairing, or other techniques). Metadata generated and associated with audio content based on estimated audio sections for the audio content is referred to herein as “section metadata” or “audio section metadata”.

In some implementations, audio sections may be determined for the selected audio content by (i) processing the audio signal to obtain initial audio sections (e.g., using one or more audio sectioning or segmentation modules), (ii) processing the audio signal to obtain estimated beats (e.g., using one or more beat estimation modules), and (iii) using both the initial audio sections and the estimated beats to define audio sections (or final audio sections) for the audio signal. For instance, the initial audio sections may be characterized by timestamps (e.g., along the temporal progression of the selected audio content) indicating the beginning and/or the end of each initial audio section. The estimated beats may similarly be characterized by timestamps. The final audio sections may be determined by temporally shifting the beginnings and/or the ends of the initial audio sections to temporally align with the temporally nearest estimated beat. In some instances, the estimated beats can comprise downbeats and/or other types of beats, and the beginnings and/or ends of the initial audio sections may be temporally aligned with specific types of beats (e.g., downbeats) to form the final audio sections for the audio signal/content.

In some implementations, the section metadata (or section timestamp data on which the section metadata is based) is generated at a client device by processing audio content using local resources at the audio device. The client device may then use the section metadata to facilitate looping playback (e.g., smart-looping, as described herein) and/or section-based song navigation (e.g., smart-seeking, as described herein) during or in preparation for playback of the audio content. In some instances, the section metadata (or section timestamp data) is generated by a remote device (e.g., a server) and is sent to and received by a client device for the client device to use to facilitate looping playback and/or section-based song navigation during or in preparation for playback of the audio content. In some instances, the section metadata (or section timestamp data) is generated at a server or other remote device that supports a web application or other interface that is accessible to client devices to facilitate looping playback and/or section-based song navigation during or in preparation for playback of the audio content. Audio sections may be determined using any combination of the foregoing resources.

In some implementations, the selected audio content is processed using one or more artificial intelligence (AI) modules to determine the audio sections for the selected audio content. An AI module can refer to any model designed to process and/or interpret data to make decisions, predictions, or classifications, assign labels, or generate other types of output. AI models can comprise various forms, such as machine-learning models, deep-learning models, neural networks, reinforcement learning models, and/or others. Various types of AI models can be used to determine audio sections, such as hidden Markov models, recurrent neural networks, convolutional neural networks (CNNs), deep reinforcement learning models, self-attention mechanisms and transformers, and/or others, which can rely on music information retrieval (MIR) techniques, audio fingerprinting and/or feature extraction, novelty-based approaches, transition detection, homogeneity-based approaches, musical property consistency identification, repetition-based approaches, recurring pattern determination, and/or other approaches. Various factors or song attributes may be utilized/considered by one or more AI models when determining audio sections, such as vocal stems, instrument stems, lyric transcriptions, chord progressions or repetitions, etc.

In some instances, multiple AI modules are used to determine the audio sections, such as a first set of one or more AI modules (e.g., audio sectioning or segmentation modules) for determining initial audio sections and a second set of one or more AI modules (e.g., beat estimation modules) for determining estimated beats (or estimated beat locations/timestamps). As noted above, the estimated beats and the initial audio sections may both be used to determine the final audio sections for the selected audio content. For example, initial audio section timestamps output by the audio sectioning or segmentation module(s) that indicate audio segment/section divisions (e.g., boundaries or transitions between segments/sections) may be temporally aligned with a nearest estimated beat (or downbeat) output by the beat estimation module(s) to obtain final audio section/segment timestamps that are aligned with beats of the audio signal. Aligning the song segments using beat information can facilitate improved looping of and/or navigation among song segments.

In some implementations, the audio sectioning or segmentation module(s) is/are configured to determine section labels or names for the audio sections (e.g., verse, chorus, instrumental, bridge, etc.), which may be presented in conjunction with representations of the audio sections in user interface displays as described hereinafter.

Although the foregoing example discusses utilizing multiple sets of one or more AI modules to obtain beat-aligned song sections, beat-aligned song sections may be obtained by a single set of one or more AI modules (e.g., a single AI model trained to receive audio information and output beat-aligned song segments). In some embodiments, the timestamp(s) of an audio segment (e.g., marking the beginning and/or the end of the audio segment) is/are estimated to its nearest downbeat such that looping playback of the audio segment, as will be discussed more below, may sound seamless (or nearly seamless) to the human ear.

Various types of processing modules may process input audio content/signals to estimate audio section locations and their corresponding audio section labels or names for the input audio content/signals, such as processing modules that utilize music information retrieval (MIR) techniques, machine learning techniques, and/or others. In some instances, one or more processing modules for estimating audio section locations and labels (also referred to herein as “audio sectioning modules” or “audio segmentation modules”) utilize a combination of Fourier transformations, neural networks, and probabilistic modeling to output sections of a song. Additional details related to an example audio segmentation process for estimating the locations of audio sections and/or their labels will now be provided.

A first act of the example audio segmentation process includes computing a spectrogram of an audio signal x using a discrete Fourier transform (other transformation methods, e.g. constant-Q transform, wavelet transform, etc. may be used). In the present example, the spectrogram is denoted as matrix S. The first act can further include applying a Hann window (or another type of window) to snippets N=2048 samples (or another quantity) with a hop size of H=441 (or another hop size). The first act can further include applying a filterbank F of triangular filters (or any type of filter) centered at the semitone frequencies of the chromatic scale (or centered at other frequencies) and taking the logarithm of a linear transformation with scale γ=1 (or another scale factor) and shift α=1×10∧(−6) (or another value) of the spectrogram to compute L (f), which may be denoted by:

$${S}_{t , f} = {\sum }_{n = 0}^{N - 1} x [ n + tH ] \cdot w [ n ] \cdot {e}^{- j \cdot 2 \cdot \frac{π \cdot f \cdot n}{N}}$$

$$L = log ( γ ⊙ \vert S \vert \cdot F + α )$$

A second act of the example audio segmentation process can include sub-sampling L in time by an integer factor p=4 (or another integer factor), resulting in a sub-sampled spectrogram Lₚ, and computing mel-frequency cepstrum coefficients (MFCCs) (or other coefficients) by applying a type-II discrete cosine transform, which may be denoted by:

$$M = {DCT}^{( II )} ( {L}_{p} ) = [ {m}_{1} , {m}_{2} , … , {m}_{N} ] ,$$

where each mᵢ are the MFCCs for time step i. The second act may further include concatenating k=10 (or another number) neighboring MFCCs into one vector, denoted as

$$= [ {m}_{i} , … , {m}_{i + k} ] .$$

The second act may further include the calculation of a distance matrix D_{i,l} that contains the cosine distance between the concatenated MFCCs, denoted as

$${D}_{1 , l} = 1 - ( \frac{{m}_{i} \cdot {m}_{i - l}}{‖ {m}_{i} ‖ ‖ {m}_{i - l} ‖} ) ,$$

for each i and I up to a maximum lag of lmax=6 (or another maximum lag). The second act may further include the calculation of a relationship matrix R_{i,l} from D_{i,l} by applying an adaptive threshold τ_{i,l} and a transfer function such as the sigmoid function (or another function), denoted as:

$$σ ( x ) = 1 / ( 1 + {e}^{- x} ) ,$$

$${R}_{i , l} = σ ( 1 - \frac{{D}_{i , l}}{{τ}_{i , l}} ) .$$

The adaptive threshold τ_{i,l} may be computed as a 10% quantile (or any other quantile) of the distances between lag neighborhood of i and i-l:

$${τ}_{i , l} = {Q}_{10 \%} ( {D}_{i , 1} , … , {D}_{i , {l}_{max}} , {D}_{i - l , 1} , … , {D}_{i - l , {l}_{max}} )$$

Any other function to compute the adaptive threshold may also be used, and it will be appreciated that the example method provided herein is provided for illustrative purposes only.

A third act of the example audio segmentation process can include passing multiple representations (such as spectrogram L, and/or one or multiple variations of relationship matrices R) through a deep convolutional neural network, denoted as f (other types of neural networks and/or machine learning modules may be utilized). The neural network may be trained on a large set of audio tracks with human-annotated audio segment timestamps and/or their labels. The third act can further include computing the segment boundary activations A^{(S)}=[α₁^{(S)}, α₂^{(S)}, . . . , α_{K}^{(S)}] (where K is the number of audio frames), and segment label probabilities A^{(L)}=[α₁^{(L)}, α₂⁽⁴⁾, . . . , α_{K}^{(L)}]. These activations can indicate the presence and/or absence segment boundaries for every time frame in the audio recording, and the probabilities of each segment label (intro, verse, chorus, etc.) for every time frame in the audio recording, respectively.

The formulas underlying f may depend on the architecture of the neural network. In one example implementation, the formulas of f use a convolution front-end with three stacks of convolution and max-pooling layers followed by downsampling in time, and a temporal convolution network with eleven layers, each with different dilation sizes. As noted above, other model types, architectures, hyperparameters, etc. may be utilized.

A fourth act of the example audio segmentation process can include the selection of audio segment boundaries from segment boundary activations A^{S} by applying an adaptive peak-finding strategy (or another strategy). The peak-finding strategy can include calculating the local moving average and local moving maximum of A^{S} (with potentially different neighborhood sizes for the moving average and the moving maximum) and selecting peaks as segmentation boundaries if they correspond to a local maximum of A^{S}, and if their value is higher than the local average of A^{S} plus a threshold τₚ. The threshold may be fixed or adaptive. The selected peaks can be considered segmentation boundaries, denoted as [b₁, b₂, . . . , b_{B}], where each bᵢ corresponds to the index of an audio frame in which a boundary was found, and B denotes the number of found boundaries, and pairs of boundaries [bᵢ, bᵢ+1] define audio sections. The fourth act of the example audio segmentation process can include a method to find the label attached to an audio section by computing the average probability of each label between time frames bᵢ and bᵢ+1, and selecting the label with the highest probability.

Various types of processing modules may process input audio content/signals to estimate beat and/or downbeat locations for the input audio content/signals, such as processing modules that utilize music information retrieval (MIR) techniques, machine learning techniques, and/or other. In some instances, one or more processing modules for estimating beat and/or downbeat locations (also referred to herein as “beat estimation modules”) utilize a combination of Fourier transformations, neural networks, and probabilistic modeling to output the beats and/or downbeats of a song. Additional details related to an example beat estimation process for estimating the locations of beats and/or downbeats associated with audio content will now be provided. Advantageously, processing modules for determining beat and/or downbeat locations (or beat timestamps) can be configured to account for variations in tempo in the input audio content/signal, such that the output beat and/or downbeat locations (or beat timestamps) can include irregularities that correspond to the tempo variations in the input audio content/signal.

A first act of the example beat estimation process includes computing a spectrogram of an audio signal x using a discrete Fourier transform (other transformation methods may be used). In the present example, the spectrogram is denoted as matrix S. The first act can further include applying a Hann window (or another type of window) to snippets N=2048 samples (or another quantity) with a hop size of H=441 (or another hop size). The first act can further include applying a filterbank F of triangular filters (or any type of filter) centered at the semitone frequencies of the chromatic scale (or centered at other frequencies) and taking the logarithm of a linear transformation with scale γ=1 (or another scale factor) and shift α=1×10∧(−6) (or another value) of the spectrogram to compute L(f), which may be denoted by:

$${S}_{t , f} = {\sum }_{n = 0}^{N - 1} x [ n + tH ] \cdot w [ n ] \cdot {e}^{- j \cdot 2 \cdot \frac{π \cdot f \cdot n}{N}}$$

$$L = log ( γ ⊙ \vert S \vert \cdot F + α )$$

A second act of the example beat estimation process can include passing this representation (e.g., L (f)) through a deep convolutional neural network, denoted as f (other types of neural networks and/or machine learning modules may be utilized). The neural network may be trained on a large set of audio tracks with human-annotated beat and downbeat positions. The second act can further include computing the beat and downbeat activations A. These activations can indicate the presence and/or absence of beats and downbeats for every time frame in the audio recording. The second act may be denoted by:

A=f(L)

The formulas underlying f may depend on the architecture of the neural network. In one example implementation, the formulas of f use a convolution front-end with three stacks of convolution and max-pooling layers followed by a temporal convolution block (e.g., a stack of dilated convolutional layers with growing dilation rates) with eleven layers, each with different dilation sizes. As noted above, other model types, architectures, hyperparameters, etc. may be utilized.

A third act of the example beat estimation process can include processing the activations through a dynamic Bayesian network (DBN) (or other type of network) that encodes musical information about the progression of downbeats and beats for multiple musical meters (e.g., 3/4 or 4/4 time signatures, or others). Each state of the DBN can correspond to a position within a musical bar. The third act can further include using the Viterbi algorithm (or other type of module) to find the state sequence with the highest probability (denoted as ŷ) given the beat and downbeat activations, denoted by:

$$\hat{y} = arg {max}_{y} P ( y \vert A )$$

A fourth act of the example beat estimation process can include selecting the elements in ŷ that correspond to beats or downbeats and computing their corresponding estimated location (e.g., temporal location or timestamp) in time by dividing their index in ŷ through the hop size H (discussed above with reference to the first act). The output of the fourth act may comprise the beat and/or downbeat timestamp data noted above (also referred to herein as “beat/downbeat timestamp data” or simply “beat timestamp data”). Advantageously, timestamp data obtained by the example beat estimation process noted above (or similar processes) may capture variations in tempo where such variations are present in the input audio content/signal. In some implementations, beat and/or downbeat timestamp data may be determined/estimated for individual stems/components of the selected audio content and may be used to generate beat/downbeat metadata for association with the individual stems/components of the selected audio content.

One will appreciate, in view of the present disclosure, that the particular aspects of the acts for estimating beats and/or downbeats described hereinabove may be varied without departing from the principles of the present disclosure, and that additional or alternative steps/operations may be utilized.

Other MIR techniques that may be utilized to facilitate beat and/or downbeat estimation may include specific onset detection models, probabilistic models, and machine learning techniques.

Onset detection focuses on identifying the beginnings of musical events, such as note attacks or percussive hits. Various methods, including energy-based, spectral-based, and phase-based approaches, can be employed to detect onset in the audio signal. Once onsets are detected, they can be used to estimate the beats and downbeat positions.

Probabilistic models, such as Hidden Markov Models (HMMs) or Dynamic Bayesian Networks (DBNs), can be used to model the temporal dependencies between beats and downbeats. These models can predict the most likely positions of beats and downbeats in a given audio signal by incorporating prior knowledge about musical structure and rhythmic patterns.

Machine learning techniques, including deep learning models like convolutional neural networks (CNNs) and recurrent neural networks (RNNs), can be trained on large datasets to automatically learn the features and patterns that are relevant for beat and downbeat detection. Once trained, these models can generalize to new, unseen music data, providing robust and accurate estimates of beat and downbeat temporal locations or timestamps.

In the example shown in FIG. 1, the “processing” of the My Recording audio content comprises using the My Recording audio content as input to one or more processing modules (e.g., audio sectioning/segmentation modules, beat estimation modules) to obtain audio section timestamp data based on the input audio content. The audio section timestamp data can include the timestamps of the beginnings and/or ends of audio sections of the My Recording audio file, which may be aligned with beats (or downbeats) of the My Recording audio file. The audio section timestamp data can be used to generate beat metadata for the My Recording audio file, which can become associated with the My Recording audio file and can be used to facilitate looping playback of one or more sections of the My Recording file and/or section-based navigation for playback of the My Recording audio file.

After processing of audio content as described above (e.g., to achieve stem separation, audio section identification/definition, etc.), the audio content may be accessed and/or interacted with in various ways. For instance, the audio tracks 102 as represented in the user interface 100 may have already been processed to determine separated stems and/or section metadata, and the audio tracks 102 may be selectable within the user interface 100 for further interaction with the audio content underlying the audio tracks 102 and/or with artifacts/outputs resulting from processing of the audio tracks 102. Similarly, after completion of the processing of the My Recordings file as conceptually depicted in FIG. 1 (or before initiation or completion of the processing), the My Recordings file may be selected within the user interface 100 for further interaction with its associated content (and/or outputs from the processing, such as separated stems and/or audio sections).

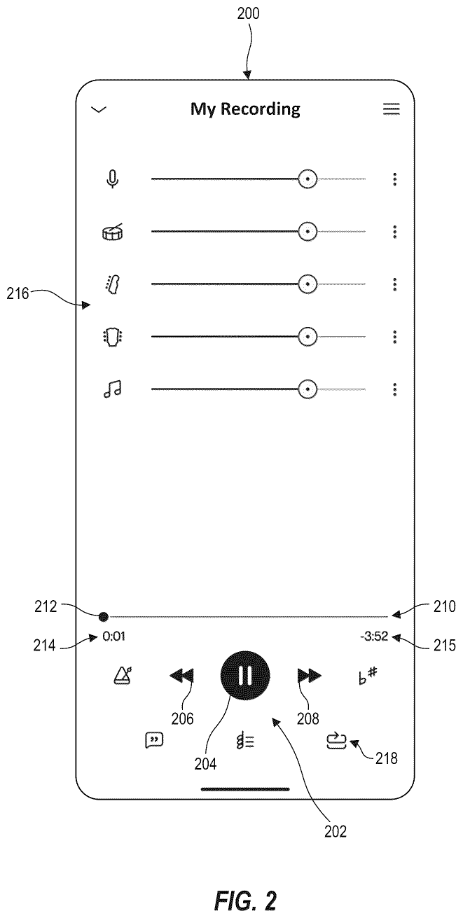

FIG. 2 illustrates an example user interface 200 that includes various elements for interacting with audio content and/or processing outputs associated with selected audio content. For instance, user interface 200 can be presented on a user device after selection of the My Recording file of the user interface 100 discussed hereinabove with reference to FIG. 1. The user interface 200 of FIG. 2 includes playback controls 202, which include a play/pause element 204, navigation elements 206 and 208 (e.g., for navigating or skipping forward or backward in time by predetermined time intervals, such as 5 seconds, 10 seconds, etc.), and a playback navigation bar 210 (e.g., for indicating playback progress and facilitating scrubbing/navigating through the selected audio content). The playback controls 202 further include a playback position marker 212 associated with the navigation bar 210 to indicate the current playback position for playing back the selected audio content (e.g., the My Recording audio file). The user interface 200 further includes time indicators 214 and 215, which can indicate the current playback time for playback of the selected audio content (e.g., time indicator 214), the remaining playback duration of the selected audio content (e.g., time indicator 215), the total duration of the selected audio content, and/or other time-related information.

The user interface 200 of FIG. 2 further includes a stem control region 216, which includes icons associated with various audio stems represented in the My Recording audio content (e.g., vocals at the top, followed in descending order by drums, bass, guitar, and remaining audio). The stem control region 216 also includes volume control sliders for adjusting the volume of individual audio stems of the My Recording content, which can enable removal, emphasis, de-emphasis, isolation, and/or other adjustments to individual audio stems during playback.

The example user interface 200 shown in FIG. 2 furthermore includes a sections element 218, which can comprise a selectable element for facilitating section-based navigation and/or looping playback of the selected audio content (e.g., the My Recording audio file, and/or stems or combinations of stems thereof). The section-based navigation and/or looping playback of the selected audio content can utilize the section metadata described hereinabove.

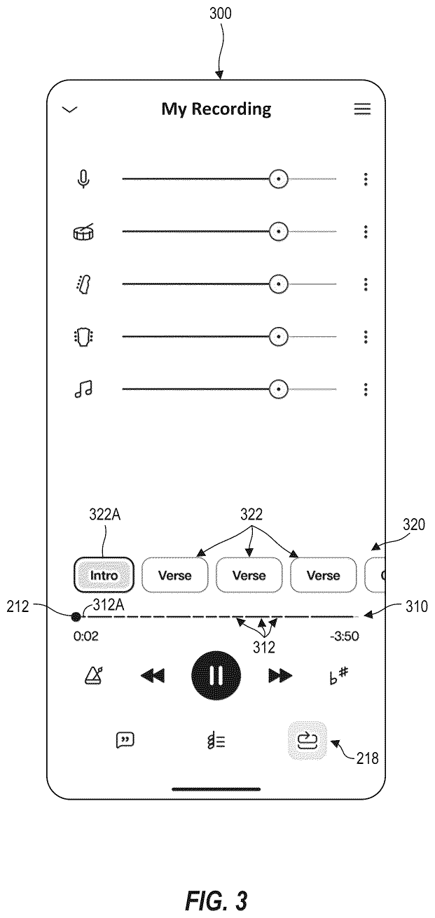

FIGS. 3, 4, 5, and 6 illustrate an example user interface 300 for controlling playback of selected audio content (e.g., the My Recording audio file, and/or stems or combinations of stems there) in a manner that uses audio sections defined for the selected audio content. The user interface 300 can represent a section or looping playback mode that is enabled after selection of the sections element 218 described hereinabove with reference to FIG. 2. FIG. 3 illustrates the user interface 300 as including a modified playback navigation bar 310 that includes or is divided into segments 312. In the example shown in FIG. 3, each of the segments 312 represents a respective audio section of the selected audio content. For example, each of the segments 312 and its corresponding audio section can represent a part of a song, such as an intro, outro, pre-chorus, chorus, interlude, bridge, verse, etc.

The segments 312 of the modified playback navigation bar 310 can be generated or defined by accessing the section metadata associated with the selected audio content or audio signal, which can indicate timestamps associated with the beginnings and/or ends of identified audio sections of the selected audio content (and which may be temporally aligned with beats of the selected audio content).

Although the example segments 312 of FIGS. 3-6 are associated with audio sections determined using section metadata as described above, segments 312 of a modified playback navigation bar 310 can be associated with audio sections defined in other ways (e.g., user-defined sections, sections defined according to regular temporal intervals, and/or others). Furthermore, although the example shown in FIGS. 3-6 depict the segments 312 as separate elements that form a discontinuous or modified playback navigation bar 310, other visual depictions of the audio sections associated with the selected audio content may be used, such as markers proximate to a continuous playback navigation bar (e.g., similar to playback navigation bar 210).

The example user interface 300 shown in FIG. 3 further includes a scrolling list 320, which may provide an additional or alternative representation of the audio sections defined for the selected audio content (e.g., the My Recording audio file, and/or stems or combinations of stems there). For instance, the example scrolling list 320 shown in FIG. 3 includes list elements 322, which may each represent a respective audio section of the selected audio content. The user interface 300 may enable users to scroll or navigate through the list elements 322, and the list elements 322 may each include a respective section label (e.g., “Intro”, “Verse”, “Pre-Chorus”, “Pre-Chorus”, “Instrumental”, etc.).

In some implementations, a list element 322 of the scrolling list 320 may become visually emphasized when the current playback position of the selected audio content is within the temporal window of the associated audio section of the selected audio content (e.g., during playback). For example, FIG. 3 depicts an instance where the selected audio content is being played back, with the playback position marker 212 indicating that the current playback position is within the first audio section of the selected audio content. In the example shown in FIG. 3, the first audio section is an “Intro” section associated with list element 322A of the scrolling list 320 and with segment 312A of the modified playback navigation bar 310. FIG. 3 depicts list element 322A (bearing the “Intro” section label) as highlighted relative to the other list elements 322 of the scrolling list 320, which can readily communicate to users that the audio currently being played back by the user device is the Intro section of the selected audio content.

In some embodiments, the modified playback navigation bar 310 can enable users to scrub/navigate through the selected audio content, similar to the playback navigation bar 210. In some implementations, the scrolling list 320 can additionally or alternatively enable users to navigate through the selected audio content (e.g., where selection of a list element 322 causes the current playback position to change to the audio section associated with the selected list element 322).

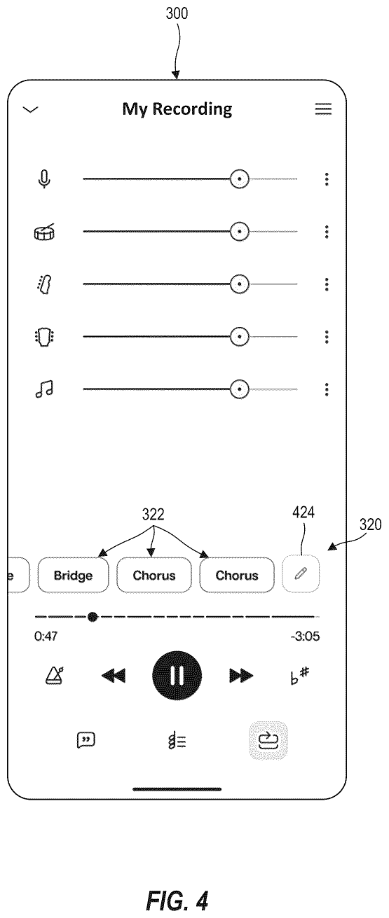

The section labels of the list elements 322 of the scrolling list 320 may be determined, as noted above, via the processing of the selected audio content (e.g., by the audio segmentation or sectioning module(s)). In some embodiments, systems implementing the disclosed subject matter are configured to receive user input for modifying the section labels associated with the audio sections. FIG. 4 depicts the user interface 300 with the scrolling list 320 scrolled to a position that reveals a modification element 424, which may be selectable to enable users to rename the section labels of the list elements 322. One will appreciate, in view of the present disclosure, that renaming of section labels may be accomplished or initiated in other ways (e.g., via a long press on a list element 322 to surface a menu of options for the list element 322, which may include renaming of the section label).

Enabling users to rename song sections can provide a number of benefits, such as aiding musicians in distinguishing and/or keeping track of certain sections/segments of a song (e.g., were multiple sections initially have the same section label determined by the audio segmentation/sectioning module(s)). In some instances, the section label automatically inferred via processing of the selected audio content can be incorrect, and a user may correct the section label by renaming it. In some implementations, user-provided section labels or corrections to such labels may be used in training AI module(s) to output more accurate section labels in future operations. For instance, the AI module(s) may utilize user-provided or user-corrected segment/section labels as training data to refine parameters for processing of future audio signals. In some implementations, the AI module(s) may be tuned based on naming preferences/conventions for specific users or groups of users.

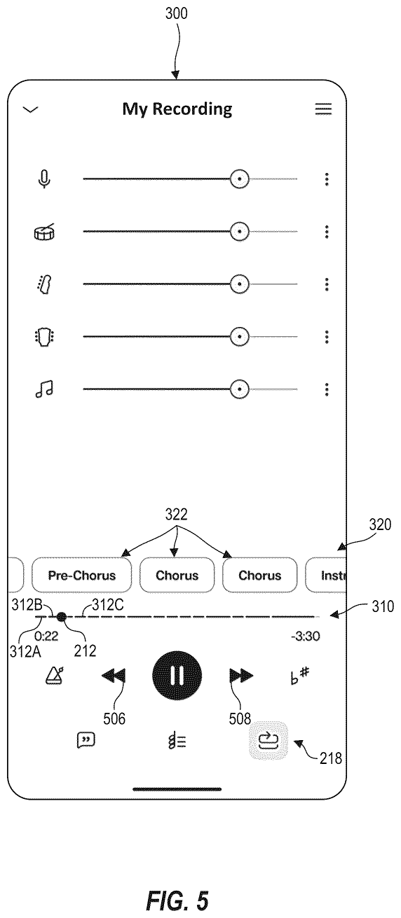

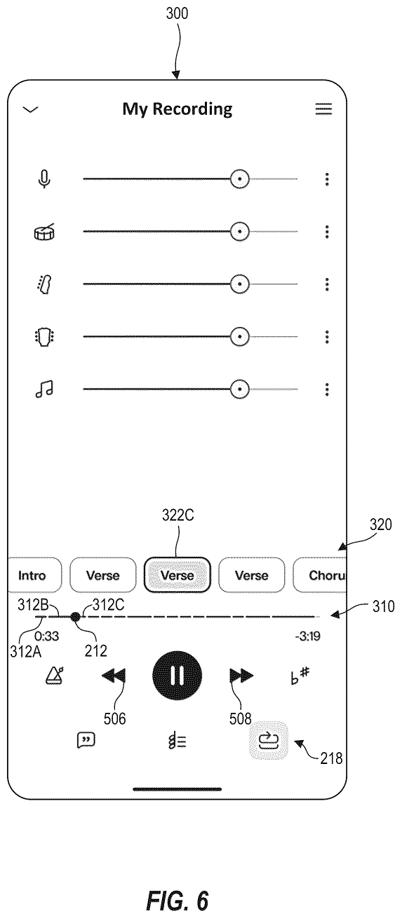

As noted above, audio sections defined for selected audio content (e.g., via section metadata for the selected audio content) can be used to facilitate navigation through the selected audio content during (or in preparation for) playback thereof. For instance, navigation elements may be used to change the current playback position for playing back the selected audio content to the beginning of the current audio section, a subsequent audio section, or a preceding audio section. FIG. 5 depicts the user interface 300 with the current playback position (denoted by the playback position marker 212) in a middle region of segment 312B of the modified playback navigation bar 310. Segment 312A precedes segment 312B, and segment 312C is subsequent to segment 312B. In the example shown in FIG. 5, the navigation elements 506 and/or 508 may be used to change or navigate the current playback position (denoted by the playback position marker 212) to the beginning of the audio section associated with the segment 312A, segment 312B, or segment 312C. For example, FIG. 6 illustrates the user interface 300 with the playback position marker 212 (indicating the current playback position) moved to the beginning of segment 312C (and its associated audio section), which may occur after selection of navigation element 508 from the instance shown in FIG. 5.

As another example, selection of navigation element 506 from the instance shown in FIG. 5 may cause movement of the playback position marker 212 to the beginning of segment 312B or to the beginning of segment 312A. In some instances, whether selection of navigation element 506 causes movement of the current playback position to the beginning of the current audio section (e.g., represented by segment 312B in the example shown in FIG. 5) or to the beginning of the preceding audio section (e.g., represented by segment 312A in the example shown in FIG. 5) can be determined by the temporal proximity of the current playback position to the beginning of the current audio section. For instance, when the current playback position is within a threshold temporal distance (e.g., 1 second, 2 seconds, etc.) to the beginning of the current audio section, selection of navigation element 506 can cause the current playback position to be changed to the beginning of the previous audio section (e.g., represented by segment 312A in the example shown in FIG. 5). In contrast, when the current playback position is equal to or greater than the threshold temporal distance from the beginning of the current audio section, selection of navigation element 506 can cause the current playback position to be changed to the beginning of the current audio section (e.g., represented by segment 312B in the example shown in FIG. 5).

In this way, rather than navigating audio content by skipping forward or backward in time by a predetermined time step (e.g., 5 seconds, 10 seconds, etc., as would be accomplished via selection of the navigation elements 206 and/or 208 described above), section-based navigation as described above can provide users with a more intuitive framework for navigating through audio content, enabling navigation directly to logical divisions between different sections of the audio content. In this regard, the section or looping playback mode (e.g., activated by selection of the sections element 218) can cause navigation elements of a user interface to change their function (e.g., from the function described above for navigation elements 206 and 208 to the function described above for navigation elements 506 and 508). The section or looping playback mode can additionally or alternatively cause a playback navigation bar to change its presentation characteristics (e.g., by implementing divisions between segments representing audio sections, or by changing from the presentation of playback navigation bar 210 to the presentation of modified playback navigation bar 310 or a variant thereon). The section or looping playback mode can additionally or alternatively cause the playback navigation bar to change its function, such as by modifying scrubbing/navigating input directed to the playback navigation bar with snapping to the nearest beginning of an audio section (e.g., for scrubbing/navigating input directed to the modified playback navigation bar 310).

FIG. 5 shows the scrolling list 320 as having been navigated to a location that does not show the list element that corresponds to the audio section associated with segment 312B. FIG. 6 shows the scrolling list 320 as having been automatically scrolled/navigated to show list element 322C, after selection of navigation element 508 as described above. List element 322C corresponds to the same audio section as segment 312C, indicating that selection of a navigation element 506 and/or 508 can automatically cause the scrolling list 320 to navigate to show the list element 322 associated with the audio section being played back (or that is queued for playback).

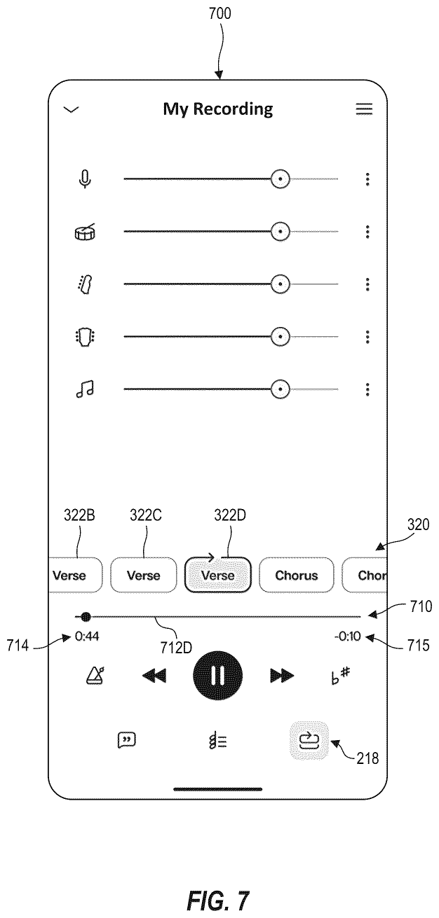

The audio sections defined for selected audio content can additionally or alternatively be used to facilitate looping playback of one or more audio sections of the audio content. FIG. 7 illustrates an example user interface 700 for controlling looping playback of a selected audio section (e.g., the My Recording audio file, or one or more stems thereof). In the example shown in FIG. 7, the user interface 700 is displayed after selection of an audio section of the selected audio content. For instance, FIG. 7 illustrates a list element 322D of the scrolling list 320 with modified presentation characteristics relative to the other list elements 322 (e.g., with an arrow extending about the list element 322D). The presentation characteristics of list element 322D can be modified after user input has been detected selecting the list element 322D (e.g., tapping, clicking, or other input directed to the list element 322D).

The user input directed to list element 322D can indicate selection of the audio section represented by list element 322D, which can trigger inclusion of the selected audio section in a looping queue. A looping queue can comprise a data or software object, file, structure, tag, label, or state or collection of states (e.g., state(s) associated with individual audio sections), or any other computer-implemented framework for tracking, recording, or logging which audio section(s) of the selected audio content is/are flagged for looping playback. Looping playback can comprise repeatedly playing back the audio section(s) represented in the looping queue without intervening user input and/or until a stop condition is satisfied).

After one or more audio sections are selected for inclusion in the looping queue, looping playback of the selected audio content using the looping queue can be initiated. In some implementations, the looping playback of the selected audio signal using the looping queue is triggered by selection of one or more audio sections for inclusion in the looping queue. In some instances, the looping playback is triggered by a separate command or event that is distinct from selection of the audio section(s) of the audio content/signal for inclusion in the looping queue. In the example shown in FIG. 7, looping playback of the selected audio content using the looping queue has been initiated by selection of list element 322D to include the associated audio section in the looping queue. One will appreciate, in view of the present disclosure, that other methods for facilitating selection of an audio section for inclusion in a looping queue are within the scope of the present disclosure (e.g., dictation input, directing input to a segment of the modified playback navigation bar 310, etc.).

In the example shown in FIG. 7, the looping playback of the selected audio content using the looping queue includes repeating playback of the audio section associated with list element 322D (which is included in the looping queue) until a stop condition is satisfied. For instance, without user intervention and without the stop condition being satisfied, playback of the audio section associated with list element 322D would continually repeat (e.g., begin again substantially immediately after completion). The looping playback using the looping queue includes refraining from playing back audio sections of the selected audio content that are not included in the looping queue, such as the audio sections associated with list elements 322B, 322C, and the other remaining list elements.

Various stop conditions may be implemented to trigger cessation of looping playback of the audio section(s) included in the looping queue, such as detecting user input removing the audio section(s) from the looping queue. For instance, in the example shown in FIG. 7, user input directed to list element 322D after its associated audio section has been included in the looping queue may trigger removal of the associated audio section from the looping queue, which may cause cessation of the looping playback of the associated audio section (e.g., reverting to user interface 300). Another example stop condition can comprise user input directed to the sections element 218 for disabling the section or looping playback mode.

In some implementations, looping playback of the audio section(s) represented in the looping queue includes presenting a modified playback navigation bar that includes one or more segments representing the audio section(s) of the looping queue. The modified playback navigation bar can omit segments representing the audio section(s) that are not included in the looping queue. For instance, FIG. 7 illustrates a modified playback navigation bar 710 that includes a single segment 712D representing the audio section included in the looping queue (i.e., the audio section associated with list element 322D). Such functionality can effectively provide users with a zoomed temporal representation of the audio section(s) included in the looping queue, which can assist users in navigating through the audio section(s) queued for looping with increased granularity and/or precision.

In the example shown in FIG. 7, the user interface 700 also includes time indicators 714 and 715. Time indicator 714 can represent the current playback time relative to the selected audio content as a whole (e.g., similar to time indicators 214). Time indicator 715 can represent the remaining playback duration of the looping queue (or the audio segment(s) included in the looping queue).

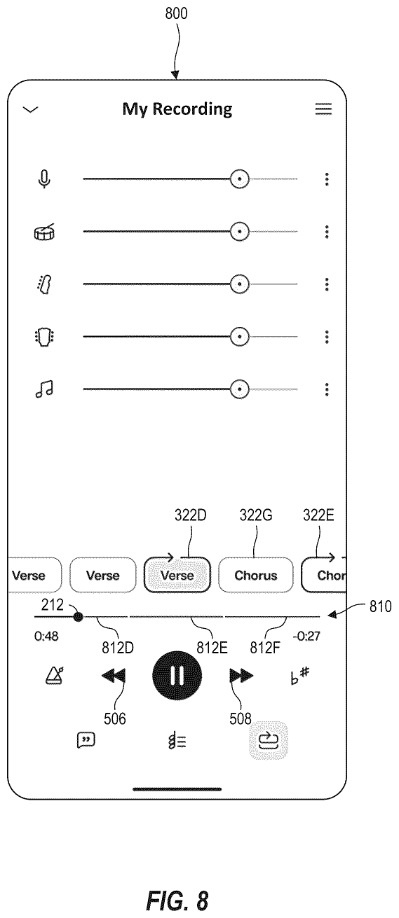

Although FIG. 7 focuses on an example in which a single audio section (i.e., the section associated with list element 322D) is selected for inclusion in the looping queue for looping playback, any quantity of audio sections of the selected audio content can be included in the looping queue. FIG. 8 illustrates an example user interface 800 in which multiple audio sections are included in the looping queue for facilitating looping playback of the selected audio sections. In particular, the audio section associated with list element 322D, the audio section associated with list element 322E, and an audio section associated with another list element not shown in FIG. 8 are selected for inclusion in the looping queue. The example user interface 800 correspondingly depicts a modified playback navigation bar 810 that includes segments 812D, 812E, and 812F, which correspond to the audio sections selected for inclusion in the looping queue.

When multiple audio sections are included in the looping queue, the looping playback can include repeating playback of the individual sections or the full looping queue as a whole. In the example shown in FIG. 8, looping playback can include repeating sequential playback of the audio sections associated with segments 812D, 812E, and 812F (e.g., one after another) until a stop condition is satisfied.

In the example shown in FIG. 8, the audio sections associated with list elements 322D and 322E are temporally separated (within the selected audio content) by an intervening audio section (associated with an intervening list element 322G) that is not included in the looping queue. Notwithstanding, the audio sections associated with list elements 322D and 322E are represented in the modified playback navigation bar 810 by segments 812D and 812E without an audio segment intervening between them. Advantageously, audio sections of selected audio content that are temporally offset from one another may be selected and brought into temporal adjacency for a looping playback session, which can improve musician practice sessions and/or other user experiences.

Although FIG. 8 focuses, in at least some respects, on an example in which the segments 812D, 812E, and 812F are arranged in the modified playback navigation bar 810 in a manner that follows the temporal ordering of their corresponding audio sections within the selected audio content, other configurations are possible. For instance, after selecting representations of audio sections for inclusion in the looping queue, a user may re-order representations of the audio sections (e.g., via drag-and-drop input or another type of input), which may change the temporal ordering of the corresponding segments represented in the modified playback navigation bar.

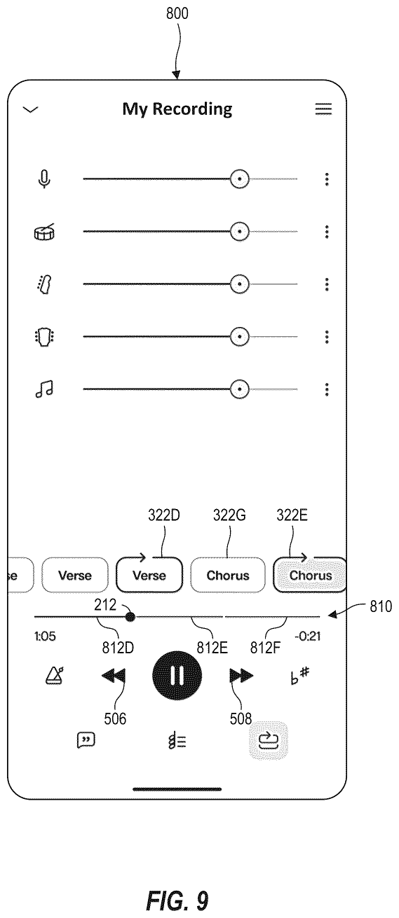

In some implementations, during looping playback of one or more audio sections of the selected audio content (e.g., using the looping queue), the navigation elements 506 and 508 may retain their section-based navigation functionality. For example, FIG. 8 illustrates an instance in which the current playback position, denoted by playback position marker 212, is within segment 812D. Under such a configuration, selection of navigation element 508 may cause the current playback position to move to the beginning of the subsequent audio section represented in the looping queue. In the example shown in FIG. 9, the subsequent audio section is associated with segment 812E, and FIG. 9 illustrates the playback position marker 212 positioned at the beginning of segment 812E after selection of navigation element 508 from the instance shown in FIG. 8. Similarly, selection of navigation element 506 can cause the playback position marker 212 to be moved to the beginning of the current segment (i.e., segment 812D in the example shown in FIG. 8) or a preceding segment (if one is present).

In some implementations, whether the navigation elements 506 and 508 cause the playback position to move the beginning of an audio section included in the looping queue (e.g., a current, preceding, or subsequent audio section) can depend on the temporal proximity of the beginnings of the candidate audio sections to the current playback position. In some embodiments, when the temporal distance between the current playback position and the beginning of the subsequent audio section satisfies a threshold temporal distance (e.g., equal to or greater than 10 seconds or another threshold), selection of navigation element 508 can cause the current playback position to advance forward by a predetermined temporal step size (which may be equal to, less than, or greater than the threshold temporal distance, such as 10 seconds). In some instances, when the temporal distance between the current playback position and the beginning of the subsequent audio section fails to satisfy the threshold temporal distance (e.g., less than 10 seconds or another threshold), selection of navigation element 508 can cause the current playback position to advance forward to the beginning of the subsequent audio section. Conversely, when the temporal distance between the current playback position and the beginning of the current or preceding audio section satisfies a threshold temporal distance (e.g., equal to or greater than 10 seconds or another threshold), selection of navigation element 506 can cause the current playback position to move backward by a predetermined temporal step size (which may be equal to, less than, or greater than the threshold temporal distance, such as 10 seconds). In some instances, when the temporal distance between the current playback position and the beginning of the preceding audio section fails to satisfy the threshold temporal distance (e.g., less than 10 seconds or another threshold), selection of navigation element 506 can cause the current playback position to move backward to the beginning of the preceding audio section. Such threshold-based functionality of the navigation elements 506 and 508 may be implemented when no audio sections are included in the looping queue (e.g., from the instance shown in FIG. 5 where all audio sections of the selected audio content are represented in the modified playback navigation bar 310).

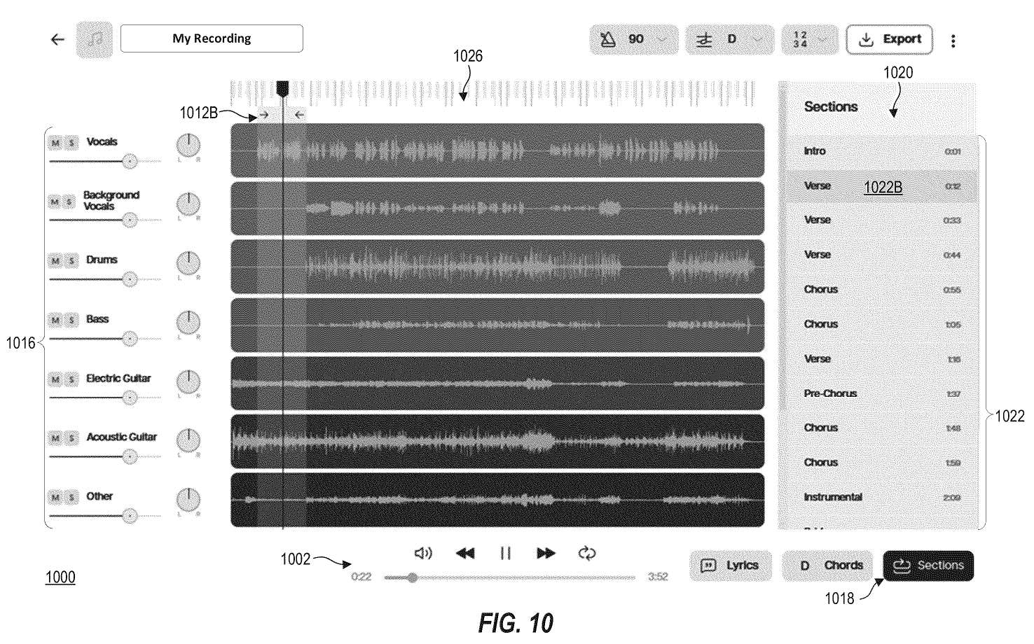

One will appreciate, in view of the present disclosure, that the particular interactable elements for activating/deactivating and/or controlling section-based audio content navigation and/or looping playback shown and described with reference to FIGS. 1-9 are provided by way of illustrative, non-limiting example only. The principles and functionality described hereinabove with reference to FIGS. 1 through 9 may be achieved with other implementation characteristics. By way of further example, FIG. 10 illustrates another user interface 1000 for facilitating section-based audio content navigation and/or looping playback for selected audio content. The user interface 1000 can be presented via a web application accessible via a web browser on any suitable device. Similar to the user interfaces 200, 300, 700, and 800, the user interface 1000 includes playback controls 1002, a stem control region 1016, and a sections element 1018 (labeled “Sections”). Each of the stems represented in the stem control region 1016 (labeled “vocals”, “drums”, “bass”, “electric guitar”, “acoustic guitar”, “other”) include a respective volume control element (under its respective label) and a respective balance element (adjacent to its respective label, denoted by “L” and “R” icons adjacent to a round adjustment feature). Each of the stems also includes a mute feature (labeled “M”) and an isolate feature (labeled “S”). The user interface 1000 includes waveform representations 1026 of each stem of the stem control region 1016.

FIG. 10 illustrates an instance in which the sections element 1018 has been selected, causing a scrolling list 1020 to be surfaced. Similar to scrolling list 320, scrolling list 1020 includes list elements 1022 associated with the various audio sections determined for the selected audio content (e.g., the My Recording audio file). The list elements 1022 include section labels and timestamps indicating the beginning of the section (relative to the selected audio content). FIG. 10 illustrates an instance in which a list element 1022B has been selected, causing its corresponding audio section to be included in a looping queue for looping playback of the corresponding audio section. FIG. 10 depicts a segment 1012B associated with the audio section that corresponds to the list element 1022B. In the example shown in FIG. 10, the segment 1012B is overlaid on the waveform representations 1026 of the stems of the stem control region 1016.

Other formats for presenting user interface displays and/or other features/components related to section-based audio content navigation and/or looping playback may be used within the scope of the present disclosure.

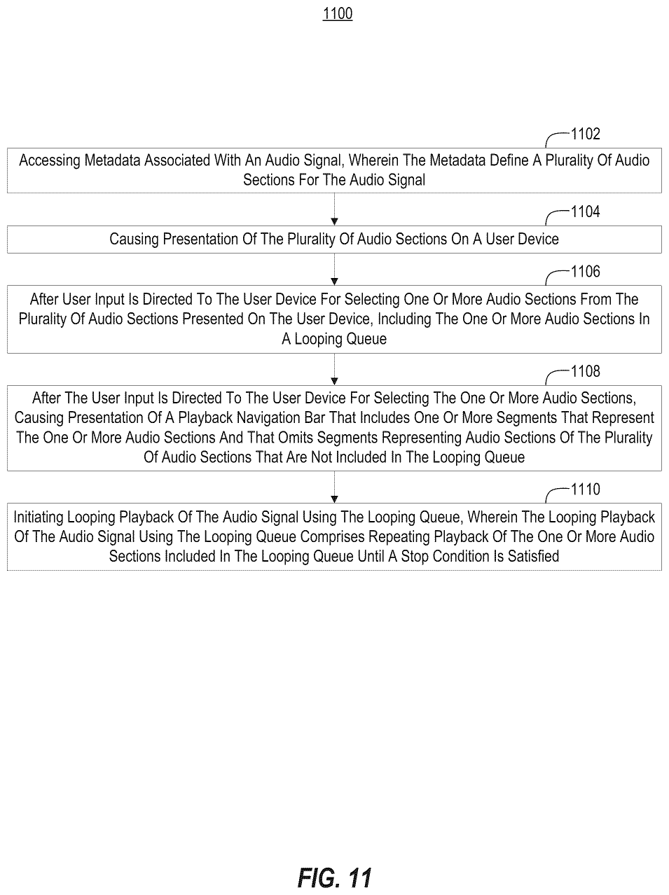

FIGS. 11, 12, and 13 illustrate example flow diagrams 1100, 1200, and 1300, respectively, depicting acts associated with facilitating beat and/or downbeat estimation and/or playback. The acts described with reference to FIGS. 11, 12, and 13 can be performed using one or more components of one or more systems 1400 described hereinafter with reference to FIG. 14, such as processor(s) 1402, storage 1404, sensor(s) 1406, I/O system(s) 1408, communication system(s) 1410, remote system(s) 1412, etc. Although the various acts described with reference to FIGS. 11, 12, and 13 may be shown and/or described in a particular order, no ordering is required unless expressly stated or unless performance of one act relies on completion of another.

Act 1102 of flow diagram 1100 of FIG. 11 includes accessing metadata associated with an audio signal, wherein the metadata define a plurality of audio sections for the audio signal. In some instances, a beginning or an end of at least some of the plurality of audio sections is/are temporally aligned with a respective beat of a plurality of estimated beats for the audio signal.

Act 1104 of flow diagram 1100 includes causing presentation of the plurality of audio sections on a user device. In some implementations, the presentation of the plurality of audio sections comprises a scrolling list where each of the plurality of audio sections is represented as a list element. In some embodiments, each list element comprises a respective section label. The respective section label(s) may be modified based on further user input directed to the user device.

Act 1106 of flow diagram 1100 includes, after user input is directed to the user device for selecting one or more audio sections from the plurality of audio sections presented on the user device, including the one or more audio sections in a looping queue. In some examples, the one or more audio sections included in the looping queue comprise multiple audio sections. In some instances, at least two of the multiple audio sections are temporally separated within the audio signal by one or more intervening audio sections that are not included in the looping queue. In some implementations, the user input directed to the user device for selecting the one or more audio sections comprises user input selecting one or more list elements of the scrolling list that represent the one or more audio sections. After the user input is directed to the user device for selecting the one or more audio sections, one or more modifications may be made to one or more presentation characteristics of the one or more list elements of the scrolling list that represent the one or more audio sections.

Act 1108 of flow diagram 1100 includes, after the user input is directed to the user device for selecting the one or more audio sections, causing presentation of a playback navigation bar that includes one or more segments that represent the one or more audio sections and that omits segments representing audio sections of the plurality of audio sections that are not included in the looping queue.

Act 1110 of flow diagram 1100 includes initiating looping playback of the audio signal using the looping queue, wherein the looping playback of the audio signal using the looping queue comprises repeating playback of the one or more audio sections included in the looping queue until a stop condition is satisfied. In some embodiments, the stop condition comprises detection of user input directed to the user device for disabling a looping playback mode. In some examples, the stop condition comprises detection of user input directed to the user device for removing the one or more audio sections from the looping queue. In some instances, the looping playback of the audio signal using the looping queue comprises refraining from playing back audio sections of the plurality of audio sections that are not included in the looping queue. Where multiple audio sections are included in the looping queue, repeating playback of the multiple audio sections can include sequentially playing back each of the multiple audio sections in accordance with a temporal ordering of the multiple audio sections within the audio signal. Where multiple audio sections are included in the looping queue, after initiating looping playback of the audio signal using the looping queue, and after user input is directed to the user device for selecting one or more navigation elements presented on the user device: (i) when a temporal distance between a current playback position and a beginning of a temporally subsequent audio section of the multiple audio sections satisfies one or more thresholds, the current playback position may be changed in accordance with a predetermined temporal step size; and (ii) when the temporal distance between the current playback position and the beginning of the temporally subsequent audio section fails to satisfy the one or more thresholds, the current playback position may be changed to the beginning of the temporally subsequent audio section.

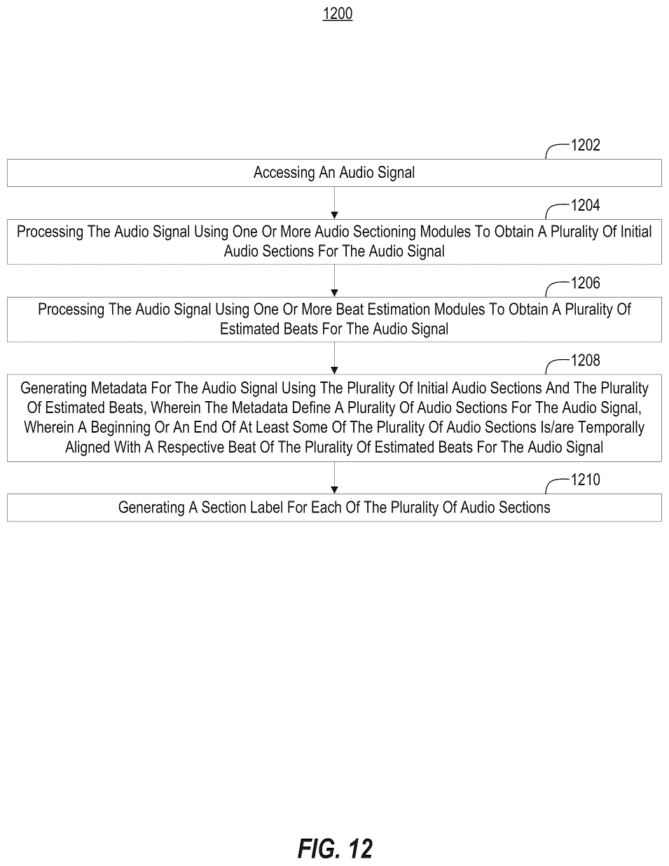

Act 1202 of flow diagram 1200 of FIG. 12 includes accessing an audio signal.

Act 1204 of flow diagram 1200 includes processing the audio signal using one or more audio sectioning modules to obtain a plurality of initial audio sections for the audio signal.

Act 1206 of flow diagram 1200 includes processing the audio signal using one or more beat estimation modules to obtain a plurality of estimated beats for the audio signal.

Act 1208 of flow diagram 1200 includes generating metadata for the audio signal using the plurality of initial audio sections and the plurality of estimated beats, wherein the metadata define a plurality of audio sections for the audio signal, wherein a beginning or an end of at least some of the plurality of audio sections is/are temporally aligned with a respective beat of the plurality of estimated beats for the audio signal. In some instances, the respective beat of the plurality of estimated beats for the audio signal comprises a downbeat.

Act 1210 of flow diagram 1200 includes generating a section label for each of the plurality of audio sections.

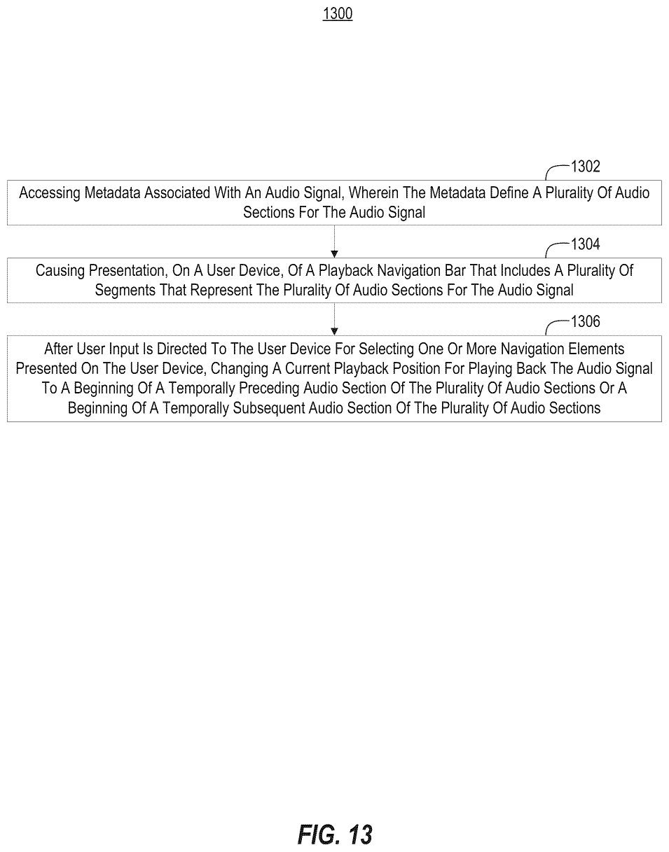

Act 1302 of flow diagram 1300 of FIG. 13 includes accessing metadata associated with an audio signal, wherein the metadata define a plurality of audio sections for the audio signal. In some implementations, a beginning or an end of at least some of the plurality of audio sections is/are temporally aligned with a respective beat of a plurality of estimated beats for the audio signal.

Act 1304 of flow diagram 1300 includes causing presentation, on a user device, of a playback navigation bar that includes a plurality of segments that represent the plurality of audio sections for the audio signal.

Act 1306 of flow diagram 1300 includes, after user input is directed to the user device for selecting one or more navigation elements presented on the user device, changing a current playback position for playing back the audio signal to a beginning of a temporally preceding audio section of the plurality of audio sections or a beginning of a temporally subsequent audio section of the plurality of audio sections.

FIG. 14 illustrates example components of a system 1400 that may comprise or implement aspects of one or more disclosed embodiments. For example, FIG. 14 illustrates an implementation in which the system 1400 includes processor(s) 1402, storage 1404, sensor(s) 1406, I/O system(s) 1408, and communication system(s) 1410. Although FIG. 14 illustrates a system 1400 as including particular components, one will appreciate, in view of the present disclosure, that a system 1400 may comprise any number of additional or alternative components.

The processor(s) 1402 may comprise one or more sets of electronic circuitries that include any number of logic units, registers, and/or control units to facilitate the execution of computer-readable instructions (e.g., instructions that form a computer program). Such computer-readable instructions may be stored within storage 1404. The storage 1404 may comprise physical system memory and may be volatile, non-volatile, or some combination thereof. Furthermore, storage 1404 may comprise local storage, remote storage (e.g., accessible via communication system(s) 1410 or otherwise), or some combination thereof. Additional details related to processors (e.g., processor(s) 1402) and computer storage media (e.g., storage 1404) will be provided hereinafter.

As will be described in more detail, the processor(s) 1402 may be configured to execute instructions stored within storage 1404 to perform certain actions. In some instances, the actions may rely at least in part on communication system(s) 1410 for receiving data from remote system(s) 1412, which may include, for example, separate systems or computing devices, sensors, and/or others. The communications system(s) 1410 may comprise any combination of software or hardware components that are operable to facilitate communication between on-system components/devices and/or with off-system components/devices. For example, the communications system(s) 1410 may comprise ports, buses, or other physical connection apparatuses for communicating with other devices/components. Additionally, or alternatively, the communications system(s) 1410 may comprise systems/components operable to communicate wirelessly with external systems and/or devices through any suitable communication channel(s), such as, by way of non-limiting example, Bluetooth, ultra-wideband, WLAN, infrared communication, and/or others.

FIG. 14 illustrates that a system 1400 may comprise or be in communication with sensor(s) 1406. Sensor(s) 1406 may comprise any device for capturing or measuring data representative of perceivable phenomenon. By way of non-limiting example, the sensor(s) 1406 may comprise one or more image sensors, microphones, thermometers, barometers, magnetometers, accelerometers, gyroscopes, and/or others.

Furthermore, FIG. 14 illustrates that a system 1400 may comprise or be in communication with I/O system(s) 1408. I/O system(s) 1408 may include any type of input or output device such as, by way of non-limiting example, a display, a touch screen, a mouse, a keyboard, a controller, a speaker and/or others, without limitation.

Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are one or more “physical computer storage media” or “hardware storage device(s).” Computer-readable media that merely carry computer-executable instructions without storing the computer-executable instructions are “transmission media.” Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in hardware in the form of computer-executable instructions, data, or data structures and that can be accessed by a general-purpose or special-purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry program code in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Disclosed embodiments may comprise or utilize cloud computing. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Those skilled in the art will appreciate that at least some aspects of the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, wearable devices, and the like. The invention may also be practiced in distributed system environments where multiple computer systems (e.g., local and remote systems), which are linked through a network (either by hardwired data links, wireless data links, or by a combination of hardwired and wireless data links), perform tasks. In a distributed system environment, program modules may be located in local and/or remote memory storage devices.

Alternatively, or in addition, at least some of the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Application-specific Standard Products (ASSPs), System-on-a-chip systems (SOCs), Complex Programmable Logic Devices (CPLDs), central processing units (CPUs), graphics processing units (GPUs), and/or others.

As used herein, the terms “executable module,” “executable component,” “component,” “module,” or “engine” can refer to hardware processing units or to software objects, routines, or methods that may be executed on one or more computer systems. The different components, modules, engines, and services described herein may be implemented as objects or processors that execute on one or more computer systems (e.g., as separate threads).

One will also appreciate how any feature or operation disclosed herein may be combined with any one or combination of the other features and operations disclosed herein. Additionally, the content or feature in any one of the figures may be combined or used in connection with any content or feature used in any of the other figures. In this regard, the content disclosed in any one figure is not mutually exclusive and instead may be combinable with the content from any of the other figures.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. For example, although the above description relates to audio files that contain music (i.e., songs), it should be appreciated that these techniques may be applied to any type of audio/video file.

With respect to the detailed description, abstract, and claims sections, it should be understood that the singular articles “a”, “an”, “the” and the like can include plural referents unless specifically excluded.

What is claimed is:

1. A system, comprising:
one or more processors; and
one or more computer-readable recording media that store instructions that are executable by the one or more processors to configure the system to:
access metadata associated with an audio signal, wherein the metadata define a plurality of audio sections for the audio signal;
cause presentation of the plurality of audio sections on a user device;
after user input is directed to the user device for selecting one or more audio sections from the plurality of audio sections presented on the user device, include the one or more audio sections in a looping queue; and
initiate looping playback of the audio signal using the looping queue, wherein the looping playback of the audio signal using the looping queue comprises repeating playback of the one or more audio sections included in the looping queue until a stop condition is satisfied.

2. The system of claim 1, wherein a beginning or an end of at least some of the plurality of audio sections is/are temporally aligned with a respective beat of a plurality of estimated beats for the audio signal.

3. The system of claim 1, wherein the stop condition comprises detection of user input directed to the user device for disabling a looping playback mode.

4. The system of claim 1, wherein the stop condition comprises detection of user input directed to the user device for removing the one or more audio sections from the looping queue.

5. The system of claim 1, wherein the looping playback of the audio signal using the looping queue comprises refraining from playing back audio sections of the plurality of audio sections that are not included in the looping queue.

6. The system of claim 1, wherein the one or more audio sections included in the looping queue comprise multiple audio sections.

7. The system of claim 6, wherein repeating playback of the multiple audio sections comprises sequentially playing back each of the multiple audio sections in accordance with a temporal ordering of the multiple audio sections within the audio signal.

8. The system of claim 6, wherein at least two of the multiple audio sections are temporally separated within the audio signal by one or more intervening audio sections that are not included in the looping queue.

9. The system of claim 6, wherein the instructions are executable by the one or more processors to configure the system to:
after initiating looping playback of the audio signal using the looping queue, and after user input is directed to the user device for selecting one or more navigation elements presented on the user device:
when a temporal distance between a current playback position and a beginning of a temporally subsequent audio section of the multiple audio sections satisfies one or more thresholds, change the current playback position in accordance with a predetermined temporal step size; and
when the temporal distance between the current playback position and the beginning of the temporally subsequent audio section fails to satisfy the one or more thresholds, change the current playback position to the beginning of the temporally subsequent audio section.

10. The system of claim 1, wherein the presentation of the plurality of audio sections comprises a scrolling list where each of the plurality of audio sections is represented as a list element.

11. The system of claim 10, wherein each list element comprises a respective section label.

12. The system of claim 11, wherein the instructions are executable by the one or more processors to configure the system to:
for at least one list element, modify the respective section label based on further user input directed to the user device.

13. The system of claim 10, wherein the user input directed to the user device for selecting the one or more audio sections comprises user input selecting one or more list elements of the scrolling list that represent the one or more audio sections.

14. The system of claim 13, wherein the instructions are executable by the one or more processors to configure the system to:
after the user input is directed to the user device for selecting the one or more audio sections, modifying one or more presentation characteristics of the one or more list elements of the scrolling list that represent the one or more audio sections.

15. The system of claim 1, wherein the instructions are executable by the one or more processors to configure the system to:
after the user input is directed to the user device for selecting the one or more audio sections, cause presentation of a playback navigation bar that includes one or more segments that represent the one or more audio sections and that omits segments representing audio sections of the plurality of audio sections that are not included in the looping queue.

16. A system, comprising:
one or more processors; and
one or more computer-readable recording media that store instructions that are executable by the one or more processors to configure the system to:
access an audio signal;
process the audio signal using one or more audio sectioning modules to obtain a plurality of initial audio sections for the audio signal;
process the audio signal using one or more beat estimation modules to obtain a plurality of estimated beats for the audio signal; and
generate metadata for the audio signal using the plurality of initial audio sections and the plurality of estimated beats, wherein the metadata define a plurality of audio sections for the audio signal, wherein a beginning or an end of at least some of the plurality of audio sections is/are temporally aligned with a respective beat of the plurality of estimated beats for the audio signal.

17. The system of claim 16, wherein the instructions are executable by the one or more processors to configure the system to:
generate a section label for each of the plurality of audio sections.

18. The system of claim 16, wherein the respective beat of the plurality of estimated beats for the audio signal comprises a downbeat.

19. A system, comprising:
one or more processors; and
one or more computer-readable recording media that store instructions that are executable by the one or more processors to configure the system to:
access metadata associated with an audio signal, wherein the metadata define a plurality of audio sections for the audio signal;
cause presentation, on a user device, of a playback navigation bar that includes a plurality of segments that represent the plurality of audio sections for the audio signal; and
after user input is directed to the user device for selecting one or more navigation elements presented on the user device, change a current playback position for playing back the audio signal to a beginning of a temporally preceding audio section of the plurality of audio sections or a beginning of a temporally subsequent audio section of the plurality of audio sections.

20. The system of claim 19, wherein a beginning or an end of at least some of the plurality of audio sections is/are temporally aligned with a respective beat of a plurality of estimated beats for the audio signal.
